(19) United States
(12) Patent Application Publication
(10) Pub. No.: US 2006/0012748 A1
(43) Pub. Date: Jan. 19, 2006

(54) Dynamic multifocal spectacle frame

(76) Inventors: Parikumar Periasamy, Dharmapuri (IN); Karthikeyan Sadagopan Arcot, Chennai (IN)

Correspondence Address: PERIASAMY PARIKUMAR, 39D, By Pass Road, Dharmapuri, 636701, IN

(21) Appl. No.: 11/166,706

(22) Filed: Jun. 23, 2005

(30) Foreign Application Priority Data
Jul. 15, 2004 (IN) 687/CHE/2004

(51) Int. Cl. G02C 7/08

(52) U.S. Cl. 351/57

(57) ABSTRACT

The dynamic multifocal spectacle frame is an improvement on the regular spectacle frame which is meant to enable the spectacle user to see the objects clearly which lie at the intermediate vision zone (i.e. 50 cm to 100 cm) e.g. computer monitor. This frame is incorporated with a mobile second set of frames fitted with the third power lens. This second set of frames are attached to the hinges provided on the lateral aspects of the spectacle frames, just below then hinge of the first frame. From here it is freely rotatable by 270° to the front i.e., in front of the first spectacle and back to the arms of the first spectacle. There are press locks provided near the nose pad and at the arms of the first frame to hold the second set of frames in position, while in use and while not in use respectively. This can be used for bifocal purposes also.

### FIELD OF INVENTION

OPTICS & REFRACTION—OPHTHALMIC MEDICINE

### BACK GROUND OF INVENTION WITH REGARD TO THE DRAWBACK ASSOCIATED WITH THE PRESENT ART

Spectacle frames used by people above 40 years of age are provided with 2 types of lenses which are meant to give clear distant (>100 cms) and near vision (50-33). Along with this as already known, a group of people in few occupations especially the computer users need an extra glass (lens) to enable them to clearly visualize the intermediate zone (i.e.) between 50-100 cm. So this third power lens should be able to be used while working with computers and be able to be kept away from the visual axis at other times. This warrants the need for a dynamic frame (mobile frame) which would be an extension of the present spectacle frames in use, to provide for the attachment of the very vital third power.

The problems with the existing bifocal spectacle frames are as follows.
1. Inability to clearly visualize the computer monitor, embroidery machine etc., at a comfortable working distance.
2. To see the monitor clearly the patients using only bifocal spectacles tend to acquire a peculiar neck position which causes strain to the eyes, neck and the back resulting in chronic problems.
3. The strain reduces work efficiency and hampers long hours of working, which is inevitable in the present pattern of jobs.
   The already existing multi-focal lenses (like progressive lenses) in a single frame have a series of compromises like distortions and aberrations. These problems are because the optical centers for distant and intermediate powers lie at different points on the glass and do not coincide with the pupillary centre of the eye at normal head position. Our dynamic multi-focal spectacle frame will eliminate these problems by providing the optical centre of the intermediate power to coincide with that of the distant power and the pupillary center of the eye thereby overcoming problems of distortions and aberrations.
   The Following Specification Describes the Nature of the Invention.

### OBJECT OF INVENTION

The principle object of the invention is to provide an extra set of frames that are mobile. The dynamic spectacle frame is incorporated with an additional mobile second set of frames fitted with the first frame mounted with the usual bifocal glasses. This will enable the user to move the dynamic frame from the side arms on both sides to bring them in front of the distant vision glass, enabling a clear zone of vision in the upright, convenient and comfortable head position while working with computers etc., which are usually placed at a distance equivalent to the intermediate distance(50-100 cm). After use, the dynamic frame (the second set of frames) will be moved back from the nose pad on the side arms on each side and clipped on firmly restoring the usual bifocal glasses effect.

The invention is sure to eliminate the difficulties faced by the computer users among people above 40 years of age i.e. presbyopes and it will definitely be helpful to overcome a sizable portion of computer induced Visual Syndrome (CVS)

Summarizing the advantages of the invention, dynamic multi-focal spectacle frames.
1. It is easy to manufacture the lenses (unlike trifocal progressive lenses)
2. It is easy to grind and fix the lenses on two separate frames
3. It is easy for the computer users to see the monitor clearly.
4. It shall be economical when compared to any other trifocal design of lenses.
5. long hours of computer usage is made possible without any strain on the eyes, neck and backbone (whereas it is unavoidable in other models of trifocal glasses) as the user of dynamic trifocals need not change his head position to see the computer monitor.
6. Dynamic multi-focal frames fitted with glasses will prevent dust and insects entering the eyes from the sides when the third power frame is left attached to the side arms.
7. It can be used as bifocal glasses also by providing the distant vision power in the first frame and near vision power in the second frame.

### DRAWING

Enclosed

### DIAGRAM DESCRIPTION

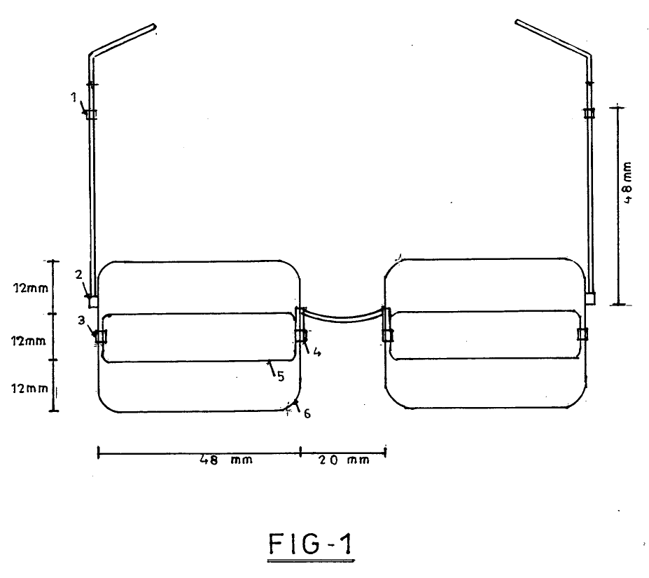

FIG. 1
1. Side lock (Press lock)
2. Hinge for the I frame
3. Hinge for the II frame
4. Central lock (press lock)
5. II frame with third power lens
6. I frame with bifocals (I and II Power)

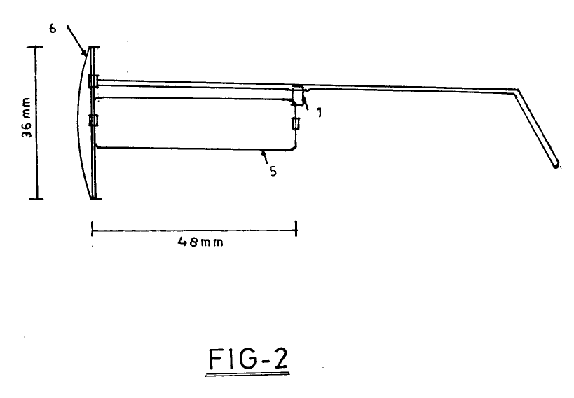

FIG. 2
1. Side lock (press lock).
2. II frame with third power lens
3. I frame with bifocals (I and II Power)

The following specification particularly describes and ascertains the nature of this invention and the manner in which it is to be used with the help of the accompanying diagrams (FIGS. 1 & 2), which illustrate the invention.

The number mentioned within brackets in the description denotes the corresponding parts of the invention as mentioned in the diagram.

The dynamic multi-focal spectacle frame is composed of two sets of frames. The first set of frames (No.6) like the regular spectacle is meant for the bifocal power glass. It has the usual hinge (No.2) for the side arms on either side.

The second set of the frames (No.5) is the one meant for the third power. This second set of frames is freely movable from the hinge (No. 3) that is at the lateral rim of the spectacle just below the hinge of the first set of frames. This second set of frames is freely rotatable by 270° back and forth.

There are set of press locks (Central lock) (No.4) on the medical aspect of the I frame just below the nose rest, on its anterior or front surface. There are also press locks (side lock) (No.1) on either side of the arms of the spectacle frame on the outer aspect, at 48 mm, from hinge (2).

When the user needs the third power, as while working with the computer, he can bring the second set of frames to the front and lock it centrally where it will lie 2 mm away from the original glasses of the first set of frames. When he completes his work, he can unlock the second set of frames from the central lock, move it backwards and lock it on either side, at the side locks.

The Metric Details of the Invention are as Follows

| | |
|---|---|
| I frame height = | 36 mms |
| I frame width = | 48 mms |
| II frame height = | 12 mms |
| II frame width = | 46 mms |

As this dynamic multifocal frame has 12 mms zone for distant vision, 12 mm zone for intermediate vision and 12 mm zone for near vision, the patient using this spectacle frame is equipped to see clearly at all distances as and when required. These measurements can be altered according to the patient's requirement. This same principle can also be used for bifocal purposes wherein the first set of frames is fitted with the distance power glass and the dynamic frames (i.e.) the second set of frames is fitted the near vision glasses. This dynamic frame lens can be brought to use when doing near work. This will provide a considerable amount of relief to the bifocal beginners to alleviate the fear and discomfort of using bifocal glasses.

We claim:

1. A dynamic multifocal spectacle frame with an additional second set of frames that are freely mobile 270° around a hinge provided at the lateral aspect of the first frame to move in and out of the visual axis for clear visual acuity at different zones of vision namely distant, near & intermediate zones as per requirement.

2. The spectacle frame according to claim 1 with the second set of frames which can be locked in front at the press locks provided on the medial side of the first frame on the front surface just below the nose pad when in use and at the press locks provided at side arm of the first frame when not in use.

3. The spectacle frame according to claim 1 & 2 with the second set of frames fitted with the lens for intermediate vision power as the need may be.
